(19) United States
(12) Patent Application Publication
(10) Pub. No.: US 2026/0268051 A1
(43) Pub. Date: Sep. 10, 2026

(54) SYNTHESIS OF REGISTER TRANSFER LEVEL (RTL) CODE TO IDENTIFY CHANGES TO THE RTL CODE TO IMPROVE A PERFORMANCE METRIC

(71) Applicant: Microchip Technology Inc., Chandler, AZ (US)

(72) Inventors: Matthew Yap, Chandler, AZ (US); Alan Nakamoto, Vancouver (CA)

(73) Assignee: Microchip Technology Inc., Chandler, AZ (US)

(21) Appl. No.: 19/234,338

(22) Filed: Jun. 11, 2025

Related U.S. Application Data
(60) Provisional application No. 63/767,003, filed on Mar. 5, 2025.

(51) Int. Cl. G06F 30/327; G06F 30/31; G06F 30/398

(52) U.S. Cl. CPC G06F 30/327; G06F 30/31; G06F 30/398

(57) ABSTRACT

A system and method for synthesis of register transfer level (RTL) code to identify changes to the RTL code to improve a performance metric are disclosed. The method may include receiving a register transfer level (RTL) code. The method may also include synthesizing the RTL code to create a physical design layout based on the RTL code. The method may additionally include comparing a performance metric of the physical design layout to a threshold. The method may include identifying a portion of the RTL code that causes the physical design layout to exceed the threshold. The method may further include generating a modification to the RTL code to correct the portion of the RTL code causing the physical design layout to exceed the threshold.

### PRIORITY

This application claims priority to U.S. Provisional Patent Application No. 63/767,003 filed Mar. 5, 2025, the contents of which are hereby incorporated in their entirety.

### TECHNICAL FIELD

The present disclosure relates to the design of integrated circuits, and in particular to synthesis of register transfer level (RTL) code to identify changes to the RTL code to improve a performance metric.

### BACKGROUND

Semiconductor chip design is a multi-phase process, beginning with defining the functionality and architecture of the chip using high-level programming languages. The functionality and architecture is translated to a hardware description language (HDL) representation that specifies the chip’s logical circuits, referred to as “front-end design.” Software tools, called electronic design automation (EDA) tools (for example, a Cadence, Synopsys, or Ansys EDA platform), are used for simulation and verification of the design. The physical layout, referred to as “back-end design,” includes arranging and connecting the components on a silicon wafer, evaluating the design for factors such as power consumption and signal integrity. The design is then converted to manufacturing instructions used to fabricate the chip.

The “shift-left” design flow in semiconductor design emphasizes moving verification and analysis tasks earlier in the design process. This approach aims to detect and resolve potential issues as soon as possible, rather than waiting until later phases, which can be significantly more costly and time-consuming. The fundamental idea is to “shift” verification and analysis activities “leftward” on the design timeline. This means performing these tasks earlier in the front-end design phases, rather than primarily during the back-end design phase.

In semiconductor design, PPAC (Power, Performance, Area, and Congestion) represents a set of metrics used to evaluate chip designs. The design may aim for a balance between these factors. Power refers to the amount of energy a chip consumes, impacting battery life, heat dissipation, and system efficiencies. Performance refers to the speed and efficiency at which a chip can execute tasks. Area refers to the physical space a chip occupies on a silicon die, impacting manufacturing cost, yield, and the amount of functionality that can be on a single chip. Congestion refers to the availability of routing resources connecting the components of the chip and whether the signal paths are efficient.

Conventional EDA tools typically have the capability to perform PPAC analysis during the back-end design phase. Some conventional EDA tools may have the capability to perform PPAC analysis during the front-end design phase, but these tools are burdensome for front-end designers, requiring the front-end designer to determine back-end impacts of the RTL code, and lack the ability to identify specific portions of the programming code impacting the various metrics in the PPAC analysis.

### SUMMARY OF THE INVENTION

Aspects provide systems and methods for synthesis of register transfer level (RTL) code to identify changes to the RTL code to improve a performance metric. Examples of the present disclosure may include a non-transitory computer-readable medium. The non-transitory computer-readable medium may include instructions executable by a processor to receive a register transfer level (RTL) code. The instructions may also cause the processor to synthesize the RTL code to create a physical design layout based on the RTL code. The instructions may cause the processor to compare a performance metric of the physical design layout to a threshold. The instructions may additionally cause the processor to identify a portion of the RTL code that causes the physical design layout to exceed the threshold. The instructions may further cause the processor to generate a modification to the RTL code to correct the portion of the RTL code causing the physical design layout to exceed the threshold.

In combination with any of the above examples, the performance metric may relate to at least one of performance, power, area, or congestion of the physical design layout.

In combination with any of the above examples, the RTL code may be in a draft form.

In combination with any of the above examples, the instructions may be further executable by the processor to compare the performance metric of the physical design layout to a second threshold. The instructions may also cause the processor to identify a second portion of the RTL code that causes the physical design layout to exceed the second threshold. The instructions may further cause the processor to generate a second modification to the RTL code to correct the second portion of the RTL code causing the physical design layout to exceed the second threshold.

In combination with any of the above examples, the instructions may be further executable by the processor to draft a change order describing the modification to the RTL code.

In combination with any of the above examples, the instructions may be further executable by the processor to read the change order. The instructions may cause the processor to edit the RTL code to create a second RTL code. The instructions may also cause the processor to synthesize the second RTL code to create a second physical design layout based on the second RTL code. The instructions may further cause the processor to compare a second performance metric of the second physical design layout to the threshold.

In combination with any of the above examples, the instructions may be further executable by the processor to draft a change order describing a modification to the physical design layout.

Alone or in combination with any of the above examples, examples of the present disclosure may include a method. The method may include receiving a register transfer level (RTL) code. The method may also include synthesizing the RTL code to create a physical design layout based on the RTL code. The method may additionally include comparing a performance metric of the physical design layout to a threshold. The method may include identifying a portion of the RTL code that causes the physical design layout to exceed the threshold. The method may further include generating a modification to the RTL code to correct the portion of the RTL code causing the physical design layout to exceed the threshold.

In combination with any of the above examples, the performance metric may relate to at least one of performance, power, area, or congestion of the physical design layout.

In combination with any of the above examples, the RTL code may be in a draft form.

In combination with any of the above examples, the method may include comparing the performance metric of the physical design layout to a second threshold. The method may also include identifying a second portion of the RTL code that causes the physical design layout to exceed the second threshold. The method may further include generating a second modification to the RTL code to correct the second portion of the RTL code causing the physical design layout to exceed the second threshold.

In combination with any of the above examples, the method may include drafting a change order describing the modification to the RTL code.

In combination with any of the above examples, the method may include reading the change order. The method may also include editing the RTL code to create a second RTL code. The method may include synthesizing the second RTL code to create a second physical design layout based on the second RTL code. The method may further include comparing a second performance metric of the second physical design layout to the threshold.

In combination with any of the above examples, the method may include drafting a change order describing a modification to the physical design layout.

Alone or in combination with any of the above examples, examples of the present disclosure may include a system. The system may include an electronic design automation (EDA) tool for development of circuit design. The system may also include a register transfer level (RTL) synthesis system integrated in the EDA tool. The RTL synthesis system may include instructions stored in non-transitory computer-readable medium and executable by a processor to receive an RTL code. The instructions may also cause the processor to synthesize the RTL code to create a physical design layout based on the RTL code. The instructions may additionally cause the processor to compare a performance metric of the physical design layout to a threshold. The instructions may cause the processor to identify a portion of the RTL code that causes the physical design layout to exceed the threshold. The instructions may further cause the processor to generate a modification to the RTL code to correct the portion of the RTL code causing the physical design layout to exceed the threshold.

In combination with any of the above examples, the performance metric may relate to at least one of performance, power, area, or congestion of the physical design layout.

In combination with any of the above examples, the RTL code may be in a draft form.

In combination with any of the above examples, the instructions may be further executable by the processor to draft a change order describing the modification to the RTL code.

In combination with any of the above examples, the instructions may be further executable by the processor to read the change order. The instructions may also cause the processor to edit the RTL code to create a second RTL code. The instructions may cause the processor to synthesize the second RTL code to create a second physical design layout based on the second RTL code. The instructions may further cause the processor to compare a second performance metric of the second physical design layout to the threshold.

In combination with any of the above examples, the instructions may be further executable by the processor to draft a change order describing a modification to the physical design layout.

### BRIEF DESCRIPTION OF THE DRAWINGS

The figures illustrate examples of systems and methods for synthesis of register transfer level (RTL) code to identify changes to the RTL code to improve a performance metric.

FIG. 1 illustrates an example system for generating and analyzing circuit designs using an analysis system between the front-end design and the back-end design for synthesis of register transfer level (RTL) code to identify changes to the RTL code to improve a performance metric, according to examples of the present disclosure;

FIG. 2 illustrates an example RTL synthesis system for generating a PPAC analysis for a set of RTL code, according to examples of the present disclosure;

FIG. 3 illustrates a flowchart of a method for performing a PPAC analysis for an example RTL code, according to examples of the present disclosure; and

FIG. 4 illustrates a more detailed flowchart of a method for performing a PPAC analysis for an example RTL code, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for synthesis of register transfer level (RTL) code to identify changes to the RTL code to improve a performance metric are provided. the disclosed RTL synthesis system improves the technology of designing integrated circuits by enabling the exploration of performance, power, area, and congestion (PPAC) during the design phase of an integrated circuit (IC) via a RTL synthesis system bridging the front-end design tools and the back-end design tools. The disclosed RTL synthesis system may mitigate the impact of discovering issues with an IC design during the back-end design phase. Late discovery of issues may cause a long turnaround time and cause architecture or front-end design rework. While shift-left design initiatives may provide a front-end designer with more exposure to PPAC analysis, this may increase the burden on the front-end designer and may result in slow functional RTL release cycles. Therefore, the disclosed RTL synthesis system may be used to perform PPAC analysis early in the design process without burdening the front-end designer with additional design tasks and may enable early action for PPAC.

Using the disclosed RTL synthesis system, IC designers may be able to receive the results of PPAC simulations without distracting the designer from performing his or her design work. The disclosed RTL synthesis system may work a physical-aware synthesis level of the IC design process. The disclosed RTL synthesis system may include the capability to suggest changes to register transfer level (RTL) design for exploration and draft change orders for upstream and downstream design tools.

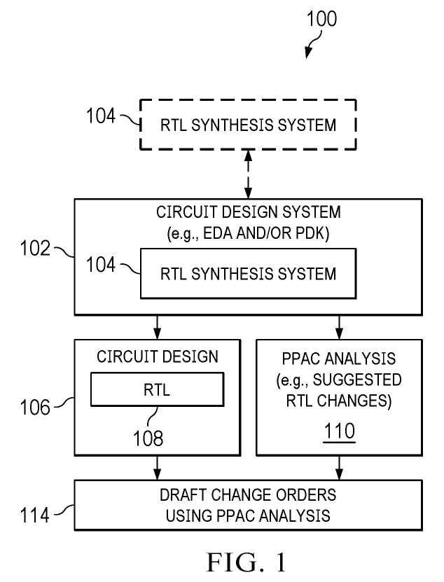

FIG. 1 illustrates an example system for generating and analyzing circuit designs using an analysis system between the front-end design and the back-end design for synthesis of register transfer level (RTL) code to identify changes to the RTL code to improve a performance metric, according to examples of the present disclosure. Example system 100 may include circuit design system 102 and RTL synthesis system 104. Circuit design system 102 may include any automated or semi-automated system or systems for generating and analyzing a circuit design 106 including RTL 108, for example, an electronic design automation (EDA) tool (for example a Cadence, Synopsys, or Ansys EDA platform) to build and analyze circuit designs or a physical design kit (PDK) specific to a particular application or technology.

RTL synthesis system 104 may include circuitry to generate PPAC analysis 110 (e.g., suggested RTL changes) for respective RTL 108 in circuit design 106. RTL synthesis system 104 may generate PPAC analysis 110 for respective circuit design 106 based on RTL 108. Circuit design system 102 may utilize PPAC analysis 110 generated by RTL synthesis system 104 to draft change orders to modify circuit design 106, RTL 108, or any combination thereof to improve PPAC analysis, as indicated at 114.

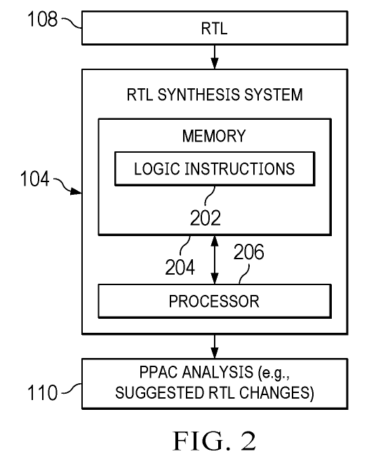

As discussed below with respect to FIG. 2, RTL synthesis system 104 may comprise software or other computer-executable instructions stored in non-transitory computer-readable medium (e.g., memory 204) and executable by one or more processors. In some examples, RTL synthesis system 104 may be integrated in circuit design system 102 (e.g., integrated in an EDA tool). In other examples, RTL synthesis system 104 may be separate from circuit design system 102.

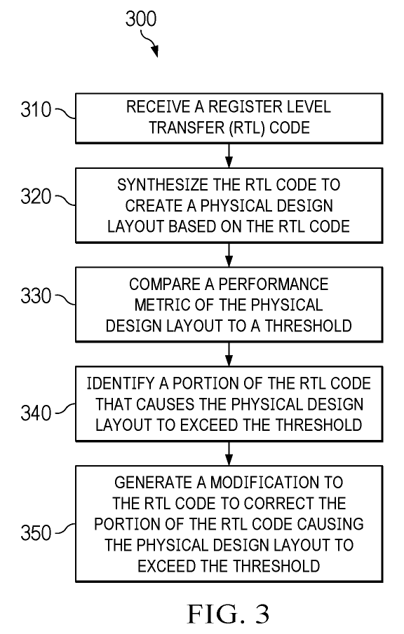

FIG. 2 illustrates an example RTL synthesis system for generating a PPAC analysis for a set of RTL code, according to examples of the present disclosure. PPAC analysis 110 may be used by circuit design system 102 to check circuit design 106, as discussed above, according to examples of the present disclosure. As shown, RTL synthesis system 104 may include computer-readable logic instructions 202 (e.g., embodied in software and/or firmware) stored in memory 204 and executable by a processor 206 to perform a respective process to generate PPAC analysis 110, for example any of the example processes shown in FIG. 3 and discussed below.

Memory 204 may include one or more type of memory device to store logic instructions 202, for example, read-only memory (ROM), random access memory (RAM, SRAM, DRAM), electrically erasable programmable read-only memory (EEPROM), a Personal Computer Memory Card International Association (PCMCIA) card, flash memory, magnetic storage, opto-magnetic storage, hardware registers, and/or any suitable selection or array of volatile or non-volatile memory. Processor 206 may comprise any system, device, or apparatus operable to interpret or execute logic instructions 202, and may include, without limitation a microprocessor, microcontroller, digital signal processor (DSP), application specific integrated circuit (ASIC), or any other digital or analog circuitry to interpret or execute program instructions and/or process data.

As shown in FIG. 2, RTL synthesis 104 may receive RTL 108, and generate an PPAC analysis 110 for RTL 108. FIG. 3 discussed below illustrates example processes implemented by RTL synthesis system 104 (e.g., by execution of logic instructions 202 by processor 206) to generate an example PPAC analysis 110 based on example input parameters 210.

FIG. 3 illustrates a flowchart of a method for performing a PPAC analysis for an example RTL code, according to examples of the present disclosure. Method 300 may be at least partially implemented by RTL synthesis system 104 shown in FIG. 2, for example by execution of respective logic instructions 202 (e.g., software) by processor 206, or any other system operable to implement method 300. Although examples have been described above, other variations and examples may be made from this disclosure without departing from the spirit and scope of these disclosed examples.

Method 300 may begin at block 310 where a RTL synthesis system may receive a register transfer level (RTL) code. The RTL synthesis system may be received from a front-end designer. The front-end designer may be responsible for defining the functionality and logic design of an integrated circuit. The RTL may be in any phase of development, including, but not limited to, early or draft form or a functional, but not yet optimal, form.

At block 320, the RTL synthesis system may synthesize the RTL code to create a physical design layout based on the RTL code. For example, the RTL synthesis system may translate the RTL code into a gate-level netlist, representative of a circuit using logic gates. The RTL synthesis system may perform physical aware synthesis based on the synthesized RTL code.

At block 330, the RTL synthesis system may compare a performance metric of the physical design layout to a threshold. Specifically, the RTL synthesis system may compare the physical design layout (created at block 320) to pre-determined thresholds for power, performance, area, congestion, or any combination thereof. For example, an integrated circuit designer may establish a threshold for an upper bound for the power consumption of an integrated circuit. The RTL synthesis system may compare the power consumption of the physical design layout to the threshold and determine whether the power consumption of the physical design layout exceeds the threshold.

At block 340, the RTL synthesis system may identify a portion of the RTL code that causes the physical design layout to exceed the threshold. For example, continuing the example described with reference to block 330, the RTL synthesis system may identify a portion of the RTL code that, when synthesized to the physical design layout, causes the physical design layout to exceed the threshold for the upper bound for power consumption.

The RTL synthesis system may also perform what-if analysis to identify the portion of the RTL code that causes the physical design layout to exceed the threshold. The analysis provided by the RTL synthesis system may be provided to designers who may use the information and collect physical-aware run data to identify any changes to make to the RTL.

At block 350, the RTL synthesis system may generate a modification to the RTL code to correct the portion of the RTL code causing the physical design layout to exceed the threshold (identified at block 340). For example, the RTL synthesis system may perform analysis to explore potential RTL changes that may result in improved PPAC of the integrated circuit (e.g., improved dynamic/leakage power). The RTL synthesis system may generate alternative RTL code that may provide improved performance or alternative RTL code that may result in the physical design layout not exceeding the threshold. The RTL synthesis system may generate the modification without interaction with the front-end designer. Therefore, the RTL synthesis system may be used to perform PPAC analysis early in the design process without consuming any bandwidth of the front-end designer and may enable early action for PPAC.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

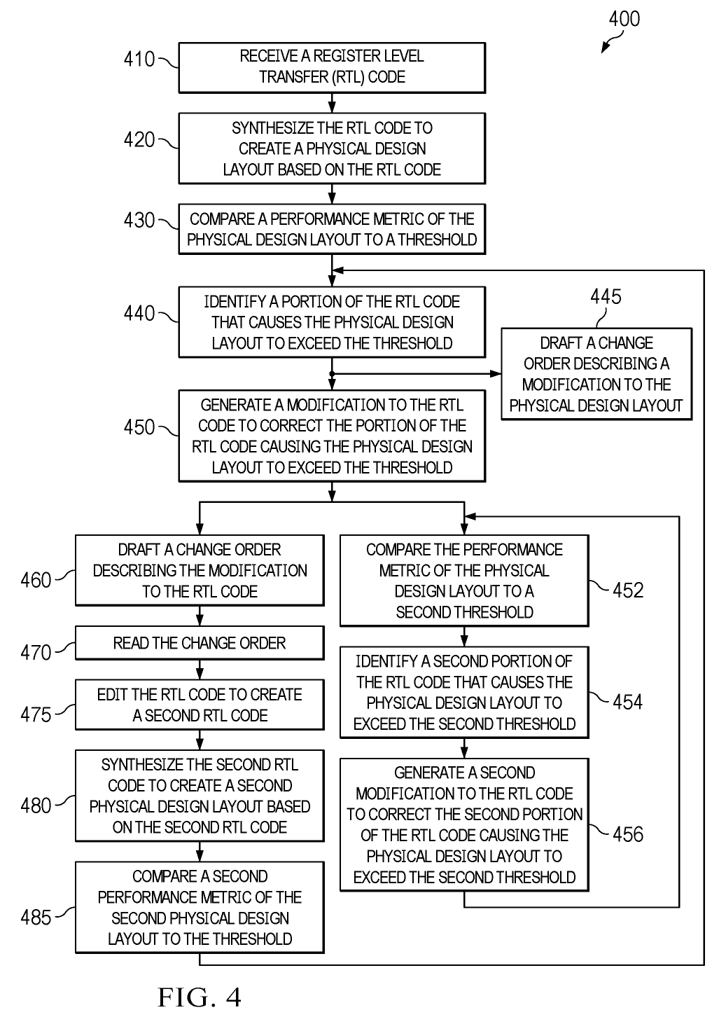

FIG. 4 illustrates a more detailed flowchart of a method for performing a PPAC analysis for an example RTL code, according to examples of the present disclosure. Method 400 may be at least partially implemented by RTL synthesis system 104 shown in FIG. 2, for example by execution of respective logic instructions 202 (e.g., software) by processor 206, or any other system operable to implement method 400. Although examples have been described above, other variations and examples may be made from this disclosure without departing from the spirit and scope of these disclosed examples.

Method 400 may begin at block 410 where an RTL synthesis system may receive a register transfer level (RTL) code. The RTL synthesis system may be received from a front-end designer. The front-end designer may be responsible for defining the functionality and logic design of an integrated circuit. The RTL may be in any phase of development, including, but not limited to, early or draft form or a functional, but not yet optimal, form.

At block 420, the RTL synthesis system may synthesize the RTL code to create a physical design layout based on the RTL code. For example, the RTL synthesis system may translate the RTL code into a gate-level netlist, representative of a circuit using logic gates. The RTL synthesis system may perform physical aware synthesis based on the synthesized RTL code.

At block 430, the RTL synthesis system may compare a performance metric of the physical design layout to a threshold. Specifically, the RTL synthesis system may compare the physical design layout (created at block 420) to pre-determined thresholds for power, performance, area, congestion, or any combination thereof. For example, an integrated circuit designer may establish a threshold for an upper bound for the power consumption of an integrated circuit. The RTL synthesis system may compare the power consumption of the physical design layout to the threshold and determine whether the power consumption of the physical design layout exceeds the threshold.

At block 440, the RTL synthesis system may identify a portion of the RTL code that causes the physical design layout to exceed the threshold. For example, continuing the example described with reference to block 430, the RTL synthesis system may identify a portion of the RTL code that, when synthesized to the physical design layout, causes the physical design layout to exceed the threshold for the upper bound for power consumption.

The RTL synthesis system may also perform what-if analysis to identify the portion of the RTL code that causes the physical design layout to exceed the threshold. The analysis provided by the RTL synthesis system may be provided to designers who may use the information and collect physical-aware run data to identify any changes to make to the RTL.

At block 445, the RTL synthesis system may draft a change order describing a modification to the physical design layout. The change order may include a suggested change that may improve the PPAC of the physical design layout. In some examples, the changes may be identified using artificial intelligence or machine learning. The RTL synthesis system may provide the change order drafted at block 445 to a back-end designer. The back-end designer may be responsible for defining the physical layout of the integrated circuit. The back-end designer may consume the suggested changes incrementally, improving the physical layout incrementally without having to redesign the integrated circuit. However, in some examples, a significant suggested change may result in a full redesign.

At block 450, the RTL synthesis system may generate a modification to the RTL code to correct the portion of the RTL code causing the physical design layout to exceed the threshold (identified at block 440). For example, the RTL synthesis system may perform analysis to explore potential RTL changes that may result in improved PPAC of the integrated circuit (e.g., improved dynamic/leakage power). The RTL synthesis system may generate alternative RTL code that may provide improved performance or alternative RTL code that may result in the physical design layout not exceeding the threshold. The RTL synthesis system may generate the modification without interaction with the front-end designer. Therefore, the RTL synthesis system may be used to perform PPAC analysis early in the design process without consuming any bandwidth of the front-end designer and may enable early action for PPAC.

At block 452, the RTL synthesis system compare the performance metric of the physical design layout to a second threshold. The second threshold may be based on iterating on the performance metric to adjust the physical design layout. For example, the second threshold may be lower than the threshold in block 430. The RTL synthesis system may perform iterative analysis of the physical design layout, varying the thresholds and performance metrics, to adjust the physical design layout.

At block 454, the RTL synthesis system may identify a second portion of the RTL code that causes the physical design layout to exceed the second threshold. The RTL synthesis system may also perform what-if analysis to identify the portion of the RTL code that causes the physical design layout to exceed the second threshold. The analysis provided by the RTL synthesis system may be provided to designers who may use the information and collect physical-aware run data to identify any changes to make to the RTL.

At block 456, the RTL synthesis system may generate a second modification to the RTL code to correct the second portion of the RTL code causing the physical design layout to exceed the second threshold. For example, the RTL synthesis system may perform analysis to explore potential RTL changes that may result in improved PPAC of the integrated circuit (e.g., improved dynamic/leakage power). The RTL synthesis system may generate alternative RTL code that may provide improved performance or alternative RTL code that may result in the physical design layout not exceeding the second threshold. The RTL synthesis system may generate the modification without interaction with the front-end designer.

Method 400 may return to block 452 and continue to iteratively analyze the physical design layout and tighten the thresholds until the physical design layout and RTL code is complete. In some examples, the RTL synthesis system may compare performance metrics for different factors in the PPAC analysis to thresholds corresponding to each factor to identify the RTL code that achieves a balance of performance, power, area, and congestion design factors. Therefore, the RTL synthesis system may be used to perform PPAC analysis early in the design process while consuming zero to minimal bandwidth of the front-end designer and may enable early action for PPAC.

At block 460, the RTL synthesis system may draft a change order describing the modification to the RTL code suggested at block 450. In some examples, the change order may be provided to a front-end designer to review and accept. The front-end designer may confirm the functionality suggested in the change order and accept and implement the changes. In some examples, the front-end designer may make additional changes on top of the changes suggested by the RTL synthesis system.

At block 470, the RTL synthesis system may read the change order from the front-end designer. In some examples, the change order may be the same change order drafted at block 460, after approval by the front-end designer. In other examples, the change order may be a modified version of the change order drafted at block 460 when the front-end designer makes additional changes on top of the change order drafted by the RTL synthesis system.

At block 475, the RTL synthesis system may edit the RTL code to create a second RTL code. Specifically, the RTL synthesis system may edit the RTL code received at block 410 to implement the changes identified in the change order read at block 470. The edited code may be the second RTL code.

At block 480, the RTL synthesis system may synthesize the second RTL code to create a second physical design layout based on the second RTL code. For example, the RTL synthesis system may translate the second RTL code into a gate-level netlist, representative of a circuit using logic gates. The RTL synthesis system may perform physical aware synthesis based on the synthesized second RTL code.

At block 485, the RTL synthesis system may compare a second performance metric of the second physical design layout to the threshold. Specifically, the RTL synthesis system may compare the second physical design layout (created at block 480) to pre-determined thresholds for power, performance, area, congestion, or any combination thereof. For example, an integrated circuit designer may establish a threshold for an upper bound for the power consumption of an integrated circuit. The RTL synthesis system may compare the power consumption of the second physical design layout to the threshold and determine whether the power consumption of the second physical design layout exceeds the threshold.

If the second performance metric exceeds the threshold, method 400 may return to block 440 to identify a portion of the second RTL code that causes the second physical design layout to exceed the threshold. Therefore, method 400 may be used to iteratively analysis RTL code and change RTL code to improve the PPAC of the integrated circuit design. In some examples, the RTL synthesis system may iteratively analyze the RTL code, using method 400, to improve the balance of PPAC without any human interaction. Once the RTL synthesis system identifies the RTL code that results in optimal PPAC, the RTL synthesis system may provide the results to a front-end designer.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

Although examples have been described above, other variations and examples may be made from this disclosure without departing from the spirit and scope of these disclosed examples.

1. A non-transitory computer-readable medium comprising instructions executable by a processor to:
receive a register transfer level (RTL) code;
synthesize the RTL code to create a physical design layout based on the RTL code;
compare a performance metric of the physical design layout to a threshold;
identify a portion of the RTL code that causes the physical design layout to exceed the threshold; and
generate a modification to the RTL code to correct the portion of the RTL code causing the physical design layout to exceed the threshold.

2. The non-transitory computer-readable medium of claim 1, wherein the performance metric relates to at least one of performance, power, area, or congestion of the physical design layout.

3. The non-transitory computer-readable medium of claim 1, wherein the RTL code is in a draft form.

4. The non-transitory computer-readable medium of claim 1, wherein the instructions are further executable by the processor to:
compare the performance metric of the physical design layout to a second threshold;
identify a second portion of the RTL code that causes the physical design layout to exceed the second threshold; and
generate a second modification to the RTL code to correct the second portion of the RTL code causing the physical design layout to exceed the second threshold.

5. The non-transitory computer-readable medium of claim 4, wherein the instructions are further executable by the processor to draft a change order describing the modification to the RTL code.

6. The non-transitory computer-readable medium of claim 5, wherein the instructions are further executable by the processor to:
read the change order;
edit the RTL code to create a second RTL code;
synthesize the second RTL code to create a second physical design layout based on the second RTL code; and
compare a second performance metric of the second physical design layout to the threshold.

7. The non-transitory computer-readable medium of claim 1, wherein the instructions are further executable by the processor to draft a change order describing a modification to the physical design layout.

8. A method, comprising:
receiving a register transfer level (RTL) code;
synthesizing the RTL code to create a physical design layout based on the RTL code;
comparing a performance metric of the physical design layout to a threshold;
identifying a portion of the RTL code that causes the physical design layout to exceed the threshold; and
generating a modification to the RTL code to correct the portion of the RTL code causing the physical design layout to exceed the threshold.

9. The method of claim 8, wherein the performance metric relates to at least one of performance, power, area, or congestion of the physical design layout.

10. The method of claim 8, wherein the RTL code is in a draft form.

11. The method of claim 8, comprising:
comparing the performance metric of the physical design layout to a second threshold;
identifying a second portion of the RTL code that causes the physical design layout to exceed the second threshold; and
generating a second modification to the RTL code to correct the second portion of the RTL code causing the physical design layout to exceed the second threshold.

12. The method of claim 11, comprising drafting a change order describing the modification to the RTL code.

13. The method of claim 12, comprising:
reading the change order;
editing the RTL code to create a second RTL code;
synthesizing the second RTL code to create a second physical design layout based on the second RTL code; and
comparing a second performance metric of the second physical design layout to the threshold.

14. The method of claim 8, comprising drafting a change order describing a modification to the physical design layout.

15. A system, comprising:
an electronic design automation (EDA) tool for development of circuit design;
a register transfer level (RTL) synthesis system integrated in the EDA tool, the RTL synthesis system including instructions stored in non-transitory computer-readable medium and executable by a processor to:
receive an RTL code;
synthesize the RTL code to create a physical design layout based on the RTL code;
compare a performance metric of the physical design layout to a threshold;
identify a portion of the RTL code that causes the physical design layout to exceed the threshold; and
generate a modification to the RTL code to correct the portion of the RTL code causing the physical design layout to exceed the threshold.

16. The system of claim 15, wherein the performance metric relates to at least one of performance, power, area, or congestion of the physical design layout.

17. The system of claim 15, wherein the RTL code is in a draft form.

18. The system of claim 15, wherein the instructions are further executable by the processor to draft a change order describing the modification to the RTL code.

19. The system of claim 18, wherein the instructions are further executable by the processor to:
read the change order;
edit the RTL code to create a second RTL code;
synthesize the second RTL code to create a second physical design layout based on the second RTL code; and
compare a second performance metric of the second physical design layout to the threshold.

20. The system of claim 15, wherein the instructions are further executable by the processor to draft a change order describing a modification to the physical design layout.
